(19) United States
(12) Patent Application Publication
(10) Pub. No.: US 2026/0370763 A1
(43) Pub. Date: Nov. 19, 2026

(54) IMAGE PROCESSING APPARATUS AND CONTROL METHOD THEREOF

(71) Applicant: CANON KABUSHIKI KAISHA, Tokyo (JP)

(72) Inventor: SATOHIRO OGA, Chiba (JP)

(21) Appl. No.: 19/676,237

(22) Filed: May 13, 2026

(30) Foreign Application Priority Data
May 16, 2025 (JP) 2025-082427

(51) Int. Cl. H04N 1/00; G02B 30/56

(52) U.S. Cl. CPC H04N 1/00411; G02B 30/56; H04N 1/00381; H04N 1/0048; H04N 1/00689

(57) ABSTRACT

An image processing apparatus according to an embodiment of the present disclosure includes a platen, a scanning unit configured to read a document placed on the platen and generate image data, a display unit, a projection unit configured to project a display of the display unit as an aerial display, and a detection unit configured to detect an operation on the aerial display. A confirmation screen is displayed on the display unit when the detection unit detects an operation after placement of a document on the platen has been detected.

### BACKGROUND

### Field of the Technology

The present disclosure relates to an image processing apparatus and a control method thereof.

### Description of the Related Art

A technology is known for combining images in midair using an optical element to display them, and a technology is known for detecting a user's gesture operation using a motion sensor. A technology is known for, by combining these technologies, providing an input/output device configured to provide a display that appears to float in midair.

Since it does not require a contact operation like touch panels or buttons, it reduces the risk of infection when used by a plurality of users and allows an operation without the transfer of dirt thereto even when a user's finger is dirty.

WO2017/141433 discloses an electronic terminal including an aerial display as an input/output device.

In a terminal including an aerial display, if an installation position of the aerial display and the set position of a scanner are close to each other, a user's hand may come into contact with the aerial display when placing a document on the scanner or removing a discharged document. As a result, an operation that is not intended by the user may be performed.

### SUMMARY

The present disclosure has been made in view of the above-described problem, and the present disclosure is directed to reducing the possibility that an operation unintended by a user is performed due to the motion of the user moving a document.

An image processing apparatus according to an embodiment of the present disclosure includes a platen, a scanning unit configured to read a document placed on the platen and generate image data, a display unit, a projection unit configured to project a display of the display unit as an aerial display, and a detection unit configured to detect an operation on the aerial display. A confirmation screen is displayed on the display unit when the detection unit detects an operation after placement of a document on the platen has been detected.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the configuration of an electronic apparatus.

FIG. 2 is a diagram illustrating the operation screens of the electronic apparatus.

FIG. 3 is a side view of an aerial display in the electronic apparatus.

FIG. 4 is a flowchart illustrating the execution of a scan function using the aerial display.

FIG. 5 is a flowchart illustrating the execution of a copy function using the aerial display.

FIG. 6 is a diagram illustrating an operation-disabled screen.

FIG. 7 is a diagram illustrating the position of the aerial display in the electronic apparatus.

### DESCRIPTION OF THE EMBODIMENTS

An embodiment of the present disclosure will be described in detail below with reference to the accompanying drawings. The embodiment to be described below does not limit the present disclosure according to the claims. All combinations of features described in the embodiment are not always essential to the means for solution according to an embodiment of the present disclosure. In the present embodiment, an electronic apparatus is assumed to be an image processing apparatus, but may also be a kiosk terminal or a medical device.

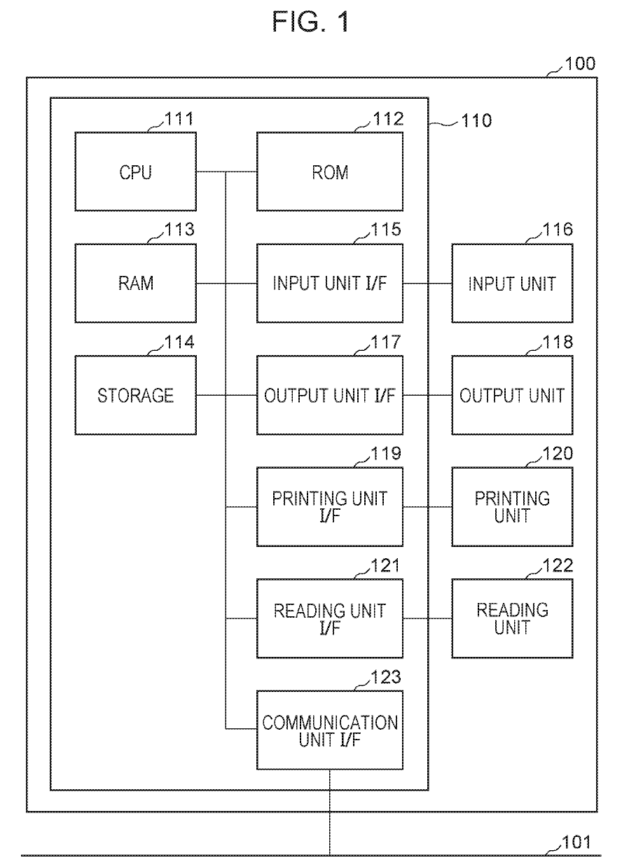

FIG. 1 is a block diagram illustrating the configuration of an electronic apparatus 100. A control unit 110 including a central processing unit (CPU) 111 controls the operation of the entire electronic apparatus 100. The CPU 111 reads a control program stored in a read-only memory (ROM) 112 or a storage 114 and performs various types of control such as reading control and printing control. The ROM 112 stores a control program executable by the CPU 111. The ROM 112 also stores a boot program, font data, etc. The RAM 113 is a main memory of the CPU 111 and is used as a work area and a temporary storage area for expanding various control programs stored in the ROM 112 and the storage 114. The storage 114 stores various programs and various pieces of setting information. In the present embodiment, the storage 114 is assumed to be a flash memory, but an auxiliary storage device such as a solid-state drive (SSD), a hard disk drive (HDD), or an embedded multimedia card (eMMC) may also be used. In the electronic apparatus 100, it is assumed that the one CPU 111 executes each piece of processing in a flowchart to be described below using one memory (the RAM 113). However, other configurations may also be employed. For example, each piece of processing in the flowchart to be described below may be executed by causing a plurality of CPUs, RAMs, ROMs, and storages to cooperate with each other. Some pieces of processing may also be executed using a hardware circuit such as an application-specific integrated circuit (ASIC) or a field-programmable gate array (FPGA). An input unit I/F 115 connects the control unit 110 and the input unit 116, and mediates the transmission of a control command from the CPU 111 to the input unit 116 and the transmission of a user input detected by the input unit 116 to the CPU 111. The input unit 116 is an aerial sensor that detects a user operation in midair. In the present embodiment, a sensor is assumed that uses infrared rays to specify XY coordinates at which a user has performed an operation with respect to a plane. However, a sensor capable of detecting more advanced gestures may also be used. An output unit I/F 117 connects the control unit 110 and an output unit 118 and transmits output information to the output unit 118. The output unit 118 is a display including an image-forming mechanism for forming an image in midair.

A printing unit I/F 119 connects a printing unit 120 and the control unit 110. The CPU 111 transfers image data to be printed (e.g., image data that is a print target) to the printing unit 120 via the printing unit I/F 119. The printing unit 120 prints an image on paper fed from a feed cassette (not illustrated). A reading unit I/F 121 connects a reading unit 122 and the control unit 110. The reading unit 122 reads an image on a document and generates image data. Image data generated by the reading unit 122 is transmitted to an external device, stored in an external storage device, or printed on recording paper by the printing unit 120. The control unit 110 is connected to a network 101 via a communication unit I/F 123. The communication unit I/F 123 transmits image data to an external device via the network 101 and receives print data from the external device via the network 101.

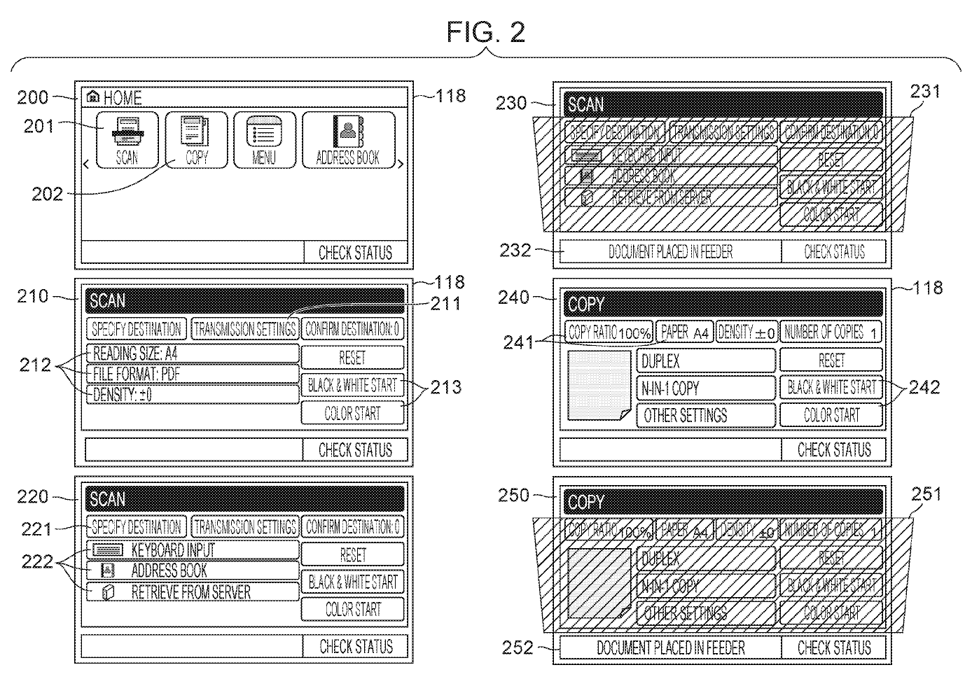

FIG. 2 is a diagram illustrating exemplary screens of the electronic apparatus 100 displayed by the output unit 118 using an aerial display.

A screen 200 is a basic screen on which the selection and setting of various functions of the electronic apparatus 100 can be performed. The screen 200 includes a scan button 201 for executing a scan function and a copy button 202 for executing a copy function. When a user's finger or the like is detected in the region of the scan button 201 or the copy button 202, the transition to a screen for the detailed settings of each function or the execution of a job can occur.

A screen 210 is used to perform transmission settings when the scan function is executed. The screen 210 is the screen that appears when the scan button 201 is selected on the screen 200. The switching between the screen 210 and a screen 220 to be described below can be performed by selecting either the transmission setting button 211 or a destination setting button 221 to be described below. The screen 210 is a setting screen mainly for performing transmission settings, where a user can select buttons such as buttons 212 to set a reading size, a file format, and a density. When a region of buttons 213 is selected, a scan job is executed, a document is read by the reading unit 122, and generated image data is transmitted to a set destination by the communication unit I/F 123.

The screen 220 is used to perform destination settings when the scan function is executed. The screen 220 is displayed when the destination setting button 221 is selected. The screen 220 is a screen mainly for performing destination settings, where a button for inputting a destination from a keyboard and a button for selecting a destination registered in an address book in advance, such as buttons 222, are displayed.

A screen 230 is a screen displayed when the electronic apparatus 100 is switched to a non-operation mode. The screen displayed as the screen 230 may be either the screen 210 or the screen 220. A region 231 indicates a sensor detection region and is a region for determining whether an operation has been detected, and is not visible to a user. For example, when a user places a document on a placement portion of an auto document feeder (ADF) or on a platen, it is possible to detect whether an operation in the region 231 is performed. At that time, when an operation from a user in the region 231 is detected, an operation-disabled screen to be described below is displayed as the non-operation mode.

A region 232 is a region that displays an indication that a document has been placed when the electronic apparatus 100 detects the placement of the document.

A screen 240 is used to perform settings when the copy function is executed. The screen 240 is the screen that appears when the copy button 202 is selected on the screen 200. The screen 240 is a screen mainly for performing print settings at the time of copying, and includes buttons such as buttons 241 for selecting, for example, a size setting, a paper setting, and a density setting. When a region of buttons 242 is selected, a copy job is executed, a document is read by the reading unit 122, and printing is performed by the printing unit 120 based on image data generated from the read document.

A screen 250 is a screen displayed when the electronic apparatus 100 is switched to the non-operation mode. A region 251 indicates a sensor detection region and is similar to the region 231. In the region 251, it can be detected whether the region has been operated by, for example, a user's finger. For example, when a predetermined period of time has elapsed after a user operated the button 241, it can be detected whether an operation in the region 251 is performed. At that time, when an operation from a user in the region 251 is detected, the operation-disabled screen to be described below is displayed as the non-operation mode. A region 252 is a region that displays an indication that a document has been placed when the electronic apparatus 100 detects the placement of the document.

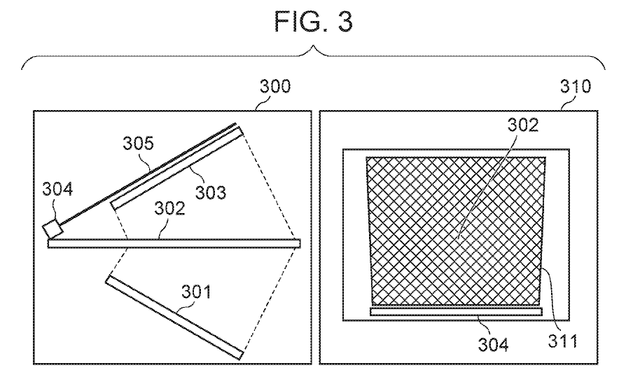

In FIG. 3, 300 is a diagram illustrating a state of the input unit 116 and the output unit 118 in a normal mode, as viewed from a side of a display of the output unit 118. The output unit 118 includes a display unit and a projection unit that projects a display of the display unit as an aerial display. A liquid crystal display 301 includes a backlight and illuminates while displaying output information received via the output unit I/F 117. An optical element 302 refracts light from the backlight of the liquid crystal display 301 and forms an image in midair. An image 303 is an image formed such that a user can visually recognize the display contents of the liquid crystal display 301 in midair. A sensor 304 is an infrared sensor for detecting a user operation. A sensor detection region 305 is a region in which the sensor 304 can detect a user operation and is not visible to a user. When a user brings a hand or a finger close to a specific region on the aerial display, the sensor detection region 305 detects the motion and determines that the region has been selected. The sensor 304 is adjusted such that the sensor detection region 305 becomes a plane parallel to the image 303, and notifies the control unit 110 of coordinates of a user operation on the image 303.

In the drawing, 310 is a diagram illustrating a state of the input unit 116 and the output unit 118 in the non-operation mode, as viewed from directly above the optical element 302. A sensor detection region 311 is equivalent to the sensor detection region 305 in the normal mode, and indicates a sensor region that becomes active in the non-operation mode. When a user brings a hand or a finger close to the sensor detection region 311, the motion is detected and it is determined that the region has been selected.

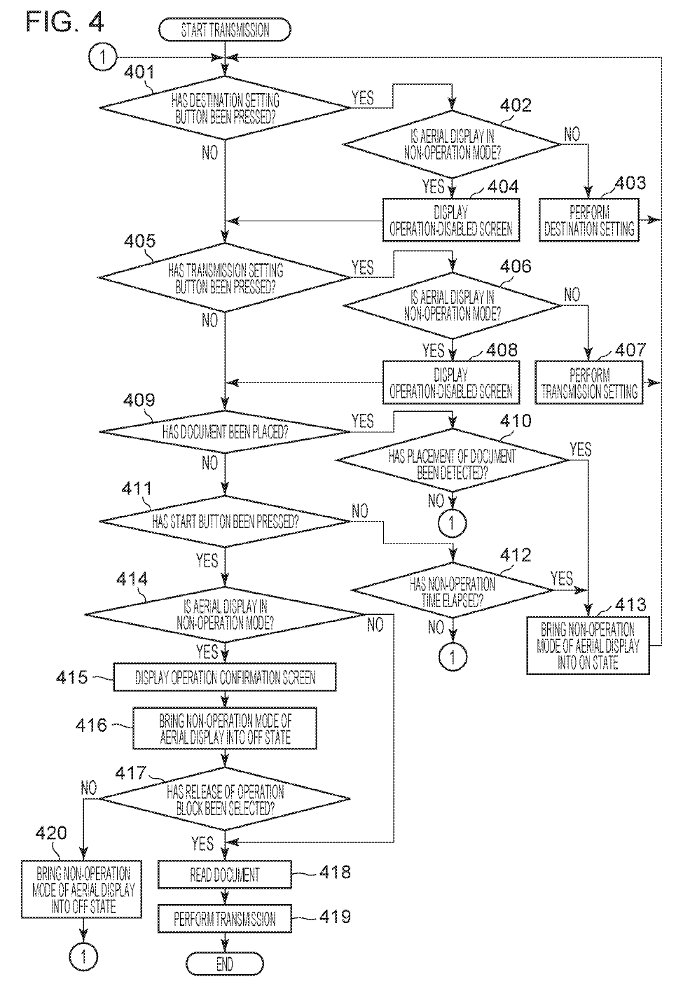

FIG. 4 is a flowchart illustrating a process for performing scan transmission using the aerial display.

This process starts when the region of the scan button 201 is selected on the screen 200. The CPU 111 executes each piece of processing.

In S401, the CPU 111 determines whether the destination setting button 221 has been selected. When the destination setting button 221 has been selected, the process proceeds to S402. When the destination setting button 221 has not been selected, the process proceeds to S405.

In S402, the CPU 111 determines whether the aerial display is in the non-operation mode. Processing for bringing the aerial display into the non-operation mode is performed in S413 to be described below. When the aerial display is in the non-operation mode, the process proceeds to S404. When the aerial display is not in the non-operation mode, the process proceeds to S403.

In S403, the CPU 111 accepts the selection of, for example, the button 222 and performs destination settings. The process proceeds to S403 when the destination settings have been performed in S401 and it has been determined in S402 that the mode is not the non-operation mode. Accordingly, a transmission destination input via a keyboard by operating the button 222 or a destination selected from an address book is reflected in the electronic apparatus 100.

In S404, the CPU 111 displays an operation-disabled screen on the output unit 118. The screen displayed here may be a confirmation screen for confirming whether the user operation is correct. Since the process proceeds to this step when it is determined in S402 that the mode is the non-operation mode, the operation-disabled screen is displayed when a user performs an operation in the sensor detection region 231. In S404, when the display of the operation-disabled screen is closed, the screen 200 can be displayed.

In S405, the CPU 111 determines whether the transmission setting button 211 has been selected. When the user has selected the region of the transmission setting button 211, the process proceeds to S406. When the user has not selected the region of the transmission setting button 211, the process proceeds to S409.

In S406, the CPU 111 determines whether the aerial display is in the non-operation mode. The processing for bringing the aerial display into the non-operation mode is performed in S413 to be described below. When the aerial display is in the non-operation mode, the process proceeds to S408. When the aerial display is not in the non-operation mode, the process proceeds to S407.

In S407, the CPU 111 performs transmission settings. The process proceeds to S407 when the transmission settings have been performed in S405 and it has been determined in S406 that the mode is not the non-operation mode. Accordingly, settings such as a reading size setting, a file format setting, and a density setting performed by the user operation are reflected.

In S408, the CPU 111 displays the operation-disabled screen. Since the process proceeds to this step when it is determined in S406 that the mode is the non-operation mode, the operation-disabled screen is displayed when the user performs an operation in the sensor detection region 231. In S408, when the display of the operation-disabled screen is closed, the screen 210 or 220 can be displayed.

In S409, the CPU 111 determines whether a document has been placed. When the document has been placed, the process proceeds to S410. When the document has not been placed, the process proceeds to S411.

In S410, the CPU 111 detects the placement of the document. The placement of the document has been determined in S409. It is determined whether the electronic apparatus 100 has actually detected the placement of the document. It is determined that the user has placed the document on the electronic apparatus 100, and the process proceeds to S413. When it is determined that a document has not been placed, the process transitions to a state of detecting the selection of a button in S401 or S405.

In S411, the CPU 111 determines whether a start button has been selected. Whether the start button has been selected is determined based on whether the user has selected a region of the button 213. When the start button has not been selected, the process proceeds to determination in S412. When the start button has been selected, the process proceeds to S414.

In S412, the CPU 111 determines whether a non-operation time has elapsed. The non-operation time is an elapsed time during which the user has not performed a screen operation on the screen 210 or 220, and is a total elapsed time when the selection of the button has not been detected in S401 or S405. When the non-operation time has continued for a predetermined period of time, it is determined that the user is not performing a setting (for example, the user is attempting to place a document), and the shift to the non-operation mode of the aerial display occurs to prevent an erroneous operation due to unintended contact.

When the elapsed time exceeds the predetermined period of time, the process proceeds to S413. When it is determined that the elapsed time does not exceed the predetermined period of time, the process transitions to a state of detecting the selection of a button in S401, S405, or S411.

In S413, the CPU 111 brings the non-operation mode of the aerial display into an ON state. When the non-operation mode is brought into the ON state, the sensor detection region of the button 232 is activated as illustrated on the screen 230 in FIG. 2. In the ON state of the non-operation mode, the display of the operation-disabled screen such as that in S404 or S408 is performed when the button has been selected in S401 or S405, it has been determined in S402 or S406 that the non-operation mode is ON, and the operation of the electronic apparatus 100 has been performed.

In S414, the CPU 111 determines whether the aerial display is in the non-operation mode. The determination in S414 is the same as the determination in S402 or S406.

In S415, the CPU 111 displays an operation confirmation screen. The operation confirmation screen is a screen for confirming, when the region of the start button is selected, whether transmission may be performed or an operation may be accepted in the ON state of the non-operation mode, and for confirming that the region of a transmission button has not been selected due to an unintended operation.

In S416, the CPU 111 brings the non-operation mode of the aerial display into an OFF state.

When this processing is performed, even if an operation is performed on the screen 210 or 220, neither the operation-disabled screen nor the operation confirmation screen is displayed.

In S417, the electronic apparatus 100 determines whether the release of an operation block has been selected. When the user selects the region of the start button in S411, it cannot be determined in the non-operation mode whether the user has actually selected the start button. Accordingly, a screen indicating that the operation is blocked is displayed, and the user is prompted to select whether to release the block. When the user agrees to the release, the process proceeds to S418. When agreement to the release has not been made, the process transitions to a state of detecting the selection of a button in S401, S405, or S411.

In S418, the CPU 111 controls the reading unit 122 to read a document and generate image data based on the set settings.

In S419, the CPU 111 controls the communication unit I/F 123 to transmit the generated image data to the set destination.

In S420, the CPU 111 brings the non-operation mode of the aerial display into the OFF state.

When this processing is performed, even if an operation is performed on the screen 210 or 220, neither the operation-disabled screen nor the operation confirmation screen is displayed.

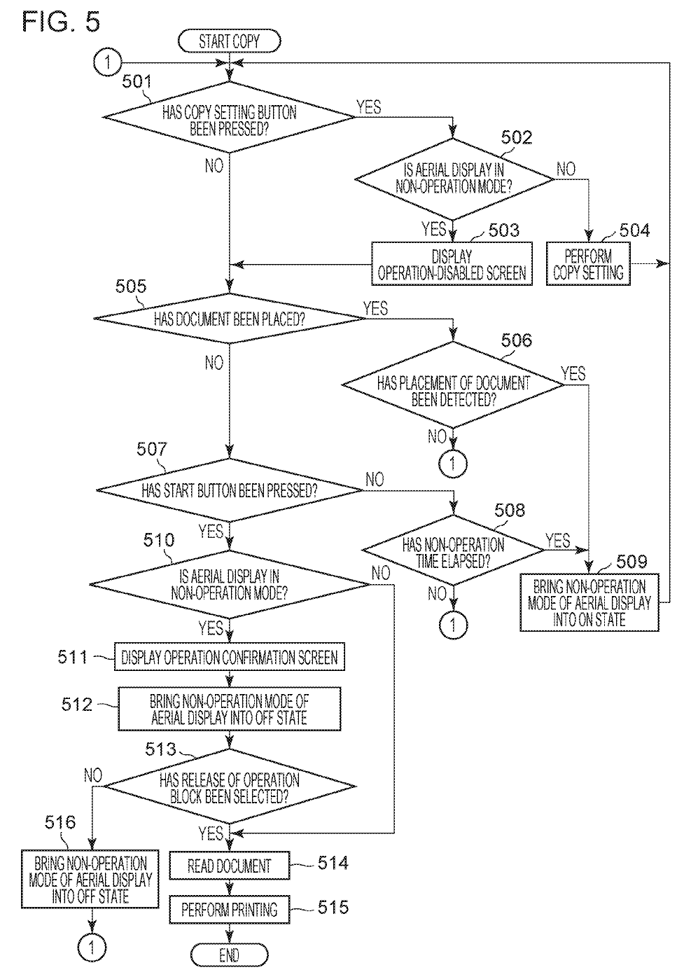

FIG. 5 is a flowchart illustrating a process for performing copying using the aerial display.

This process starts when a region of the copy button 202 is selected on the screen 200.

In S501, the electronic apparatus 100 determines whether a copy setting button has been selected. When copy settings have been performed, the process proceeds to S502. When the copy settings have not been performed, the process proceeds to S505.

In S502, the electronic apparatus 100 determines whether the aerial display is in the non-operation mode. The processing for bringing the aerial display into the non-operation mode is performed in S509 to be described below. When the aerial display is in the non-operation mode, the process proceeds to S503. When the aerial display is not in the non-operation mode, the process proceeds to S504.

In S503, the electronic apparatus 100 displays the operation-disabled screen. When a user performs an operation on the sensor detection region of the buttons 242, the operation-disabled screen is displayed. The same processing as that in S404 is performed. In S503, when the display of the operation-disabled screen is closed, the screen 240 can be displayed.

In S504, the electronic apparatus 100 performs copy settings. The process proceeds to S504 when the copy settings have been performed in S501 and it has been determined in S502 that the mode is not the non-operation mode. Settings such as a size setting, a paper setting, and a density setting performed by a user operation are reflected in the electronic apparatus 100.

In S505, the electronic apparatus 100 determines whether a document has been placed. The same processing as that in S409 is performed in determining whether a document has been placed. This state indicates a state in which the user has not performed a copy setting operation, and it is determined that the user is placing a document on the ADF. When the document has been placed, the process proceeds to S506. When the document has not been placed, the process proceeds to S507.

In S506, the electronic apparatus 100 detects the placement of the document. The determination processing in S506 is the same as that in S410. When it is determined that the user has placed the document on the electronic apparatus 100, the process proceeds to S509. When it is determined that a document has not been placed, the process transitions to a state of detecting the selection of a button in S501.

In S507, the electronic apparatus 100 determines whether the start button has been selected. Whether the start button has been selected is determined based on whether the user has selected the region of the buttons 242. When the start button has not been selected, the process proceeds to determination in S508. When the start button has been selected, the process proceeds to S510.

In S508, the electronic apparatus 100 determines whether a non-operation time has elapsed. The non-operation time is an elapsed time during which the user has not performed a screen operation on the screen 240, and is a total elapsed time when the selection of the button has not been detected in S501. When the non-operation time has continued for a predetermined period of time, it is determined that the user is not performing a setting (for example, the user is attempting to place a document), and the shift to the non-operation mode of the aerial display occurs to prevent an erroneous operation due to unintended contact. When the elapsed time exceeds the predetermined period of time, the process proceeds to S509. When it is determined that the elapsed time does not exceed the predetermined period of time, the process transitions to the state of detecting the selection of a button in S501.

In S509, the electronic apparatus 100 brings the non-operation mode of the aerial display into an ON state. In the ON state of the non-operation mode, the display of the operation-disabled screen such as that in S503 is performed when the button has been selected in S501, it has been determined in S502 that the non-operation mode is ON, and the operation of the electronic apparatus 100 has been performed.

In S510, the electronic apparatus 100 determines whether the aerial display is in the non-operation mode. The determination in S510 is the same as the determination in S502. When the aerial display is in the non-operation mode, the process proceeds to S511. When the aerial display is not in the non-operation mode, the process proceeds to S514.

In S511, the electronic apparatus 100 displays an operation confirmation screen. The operation confirmation screen is a screen for confirming, when the region of the start button is selected, whether transmission may be performed or an operation may be accepted in the ON state of the non-operation mode, and for confirming that the region of a transmission button has not been selected due to an unintended operation.

In S512, the electronic apparatus 100 brings the non-operation mode of the aerial display into an OFF state. When this processing is performed, even if an operation is performed on the screen 240, neither the operation-disabled screen nor the operation confirmation screen is displayed.

In S513, the electronic apparatus 100 determines whether the release of an operation block has been selected. When the user selects the region of the start button in S507, it cannot be determined in the non-operation mode whether the user has actually selected the start button. Accordingly, a screen indicating that the operation is blocked is displayed, and the user is prompted to select whether to release the block. When the user agrees to the release, the process proceeds to S514. When agreement to the release has not been made, the process transitions to a state of detecting the selection of a button in S501 or S507.

In S514, the electronic apparatus 100 reads the document. Reading of the document is performed by the reading unit 122, and image data for printing is generated.

In S515, the electronic apparatus 100 performs transmission. Printing is performed by the printing unit 120.

In S516, the electronic apparatus 100 brings the non-operation mode of the aerial display into the OFF state.

When this processing is performed, even if an operation is performed on the screen 240, neither the operation-disabled screen nor the operation confirmation screen is displayed.

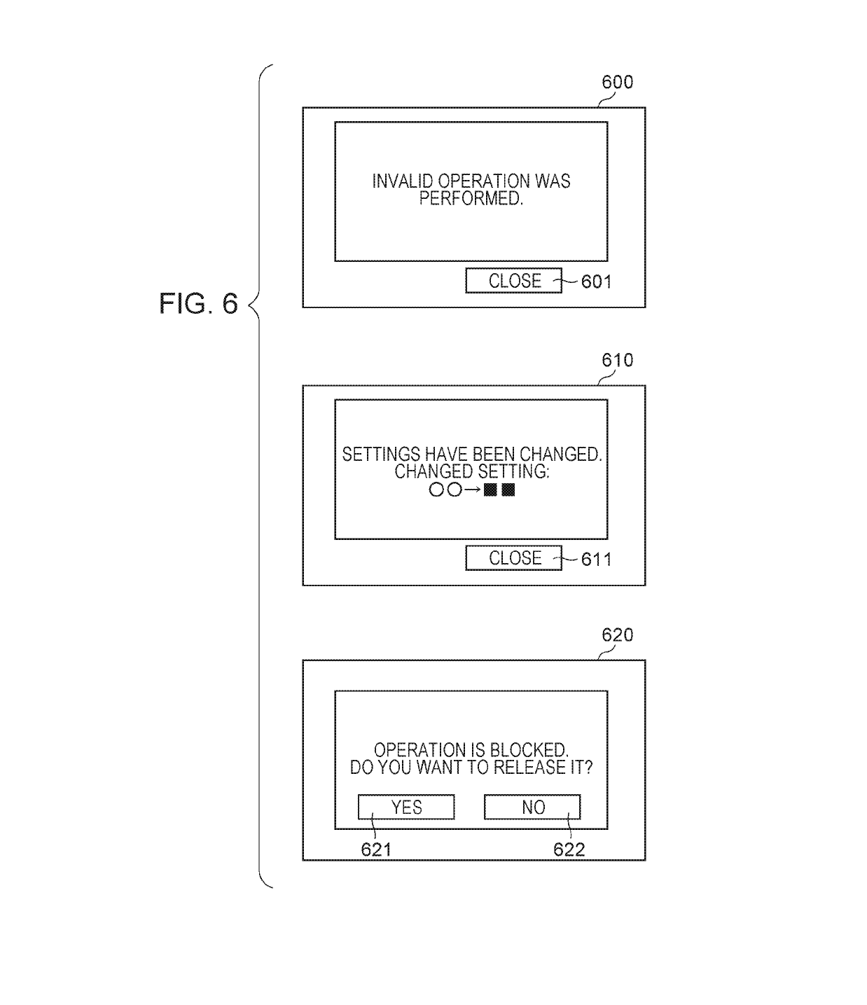

FIG. 6 illustrates exemplary operation-disabled screens displayed by the electronic apparatus 100 in the non-operation mode. A screen 600 indicates that an invalid operation has been detected and an operation has been blocked in the ON state of the non-operation mode. The non-operation mode is brought into the ON state in S413 or S509, and the screen 600 is displayed when an operation in the region 231 or 251 is detected. This is an example of the operation-disabled screen displayed in S404, S408, or S503. The screen 600 includes a close button 601. By selecting a region of the close button 601, the operation-disabled screen can be closed. The process can proceed to S405, S409, or S505.

A screen 610 indicates that an invalid operation has been performed and part of settings has been changed in the ON state of the non-operation mode. This is an example of the operation-disabled screen displayed in S404, S408, or S503 and is another example of the screen 600. The screen 610 does not indicate that an operation has been blocked in the non-operation mode, but indicates that a setting has been changed by an operation and warns a user. Similarly to the screen 600, the screen 610 includes a close button 611 having the same function as the close button 601.

A screen 620 is a screen prompting a user to release the operation block in the ON state of the non-operation mode.

The screen 620 is an example of the operation confirmation screen displayed in S415 or S511. The screen 620 is displayed when the start button is selected in S411 or S507 and the non-operation mode is in the ON state. The screen 620 includes buttons 621 and 622 that are used to determine in S417 or S513 whether the operation confirmation screen has been checked.

As described above, when placement of a document on the platen is detected and then a detection unit detects an operation, the output unit 118 can display the confirmation screen. The confirmation screen includes a message indicating that the operation is blocked and also prompts a user to confirm whether to release the block. The operation detected here is an operation related to transmission settings included in a display represented as an aerial display, and the transmission settings are used to transmit image data generated by a scanning unit such as the reading unit 122.

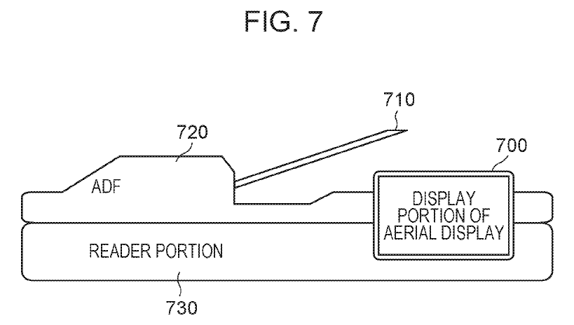

FIG. 7 is a diagram illustrating positions of the electronic apparatus 100 and an aerial display projection unit 302.

A reference numeral 700 indicates the position of a screen displayed by the electronic apparatus 100 using the projection unit 302. The display screen may be the screen illustrated in FIG. 2. A document tray 710 is for stacking documents thereon. In the present embodiment, when a user operates a screen at the position 700 and stacks documents on the document tray 710, unintended contact may occur and a setting may be changed.

An ADF 720 automatically conveys a document to a reader portion 730. The ADF 720 is an example of a document conveying unit. As in S410 or S506, placement of a document stacked on the document tray 710 can be detected.

The reader portion 730 reads a document conveyed from the ADF 720. This is a function of the reading unit 122 included in the electronic apparatus 100, and converts the read image into image data, such as binary data. The reader portion 730 can read a document that is directly placed thereon without using the ADF 720.

As described above, in the present embodiment, based on triggers such as timing of a user operation or placement of a document, it is determined whether to accept an operation on the aerial display, and a warning for preventing an erroneous operation or an operation block is performed. Accordingly, even when unintended contact occurs, execution of a job unintended by a user can be prevented.

It is possible to reduce the possibility that an operation unintended by a user is performed due to the motion of the user moving a document.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082427, filed May 16, 2025, which is hereby incorporated by reference herein in its entirety.

What is claimed is:

1. An image processing apparatus comprising:
a platen;
at least one memory storing instructions; and
at least one processor that, upon execution of the stored instructions, configures the at least one processor to operate as:
a scanning unit configured to read a document placed on the platen and generate image data;
a display unit;
a projection unit configured to project a display of the display unit as an aerial display; and
a detection unit configured to detect an operation on the aerial display,
wherein a confirmation screen is displayed on the display unit when the detection unit detects the operation after placement of the document on the platen has been detected.

2. The image processing apparatus according to claim 1, wherein the confirmation screen includes a display indicating that a block of the operation is performed.

3. The image processing apparatus according to claim 2, wherein the confirmation screen is a screen for confirming whether to release the block.

4. The image processing apparatus according to claim 1, wherein the detected operation is related to a transmission setting included in the display displayed as the aerial display.

5. The image processing apparatus according to claim 4, wherein the transmission setting is used to transmit image data generated by the scanning unit.

6. A control method of an image processing apparatus including a platen, a scanning unit configured to read a document placed on the platen and generate image data, and a display unit, comprising:
projecting a display of the display unit as an aerial display; and
detecting an operation on the aerial display,
wherein a confirmation screen is displayed on the display unit when the operation is detected in the detecting after placement of the document on the platen has been detected.

7. The control method according to claim 6, wherein the confirmation screen includes a display indicating that a block of the operation is performed.

8. The control method according to claim 7, wherein the confirmation screen is a screen for confirming whether to release the block.

9. The control method according to claim 6, wherein the detected operation is related to a transmission setting included in the display displayed as the aerial display.

10. The control method according to claim 9, wherein the transmission setting is used to transmit image data generated by the scanning unit.
